(19) United States
(12) Patent Application Publication
(10) Pub. No.: US 2023/0383094 A1
(43) Pub. Date: Nov. 30, 2023

(54) ANTI-DRUMMING COMPOSITIONS WITH EMULSION POLYMER, HIGH DENSITY FILLER, DISPERSING AID AND VOLUME CONTRACTION OR LOW VOLUME EXPANSION

(71) Applicant: BASF SE, Ludwigshafen am Rhein (DE)

(72) Inventors: Peter PREISHUBER-PFLUEGL, Ludwigshafen am Rhein (DE); Andreas ZIEHER, Ludwigshafen am Rhein (DE); Dirk WULFF, Ludwigshafen am Rhein (DE)

(21) Appl. No.: 18/031,377

(22) PCT Filed: Oct. 7, 2021
(86) PCT No.: PCT/EP2021/077741

§ 371 Date: Apr. 12, 2023

(30) Foreign Application Priority Data
Oct. 14, 2020 (EP) 20201818.0

(51) Int. Cl. C08K 7/10; C08F 2/26; C08F 120/16; B60R 13/08; C08L 33/10

(52) U.S. Cl. CPC C08K 7/10; C08F 2/26; C08F 120/16; B60R 13/08; C08L 33/10

(57) ABSTRACT

A description is given for an anti-drumming composition comprising a polymer dispersion comprising at least one dispersed (meth)acrylic polymer obtainable by emulsion polymerization of radically polymerizable (meth)acrylic monomers, a high density filler mixture and a specific dispersing aid, wherein the anti-drumming composition has either a volume contraction or only a very low volume expansion after drying.

The invention relates to an anti-drumming composition comprising a polymer dispersion comprising a dispersed (meth)acrylic polymer obtainable by emulsion polymerization of radically polymerizable (meth)acrylic monomers, a high density filler mixture and a dispersing aid, wherein the anti-drumming composition has either a volume contraction or only a very low volume expansion after drying. The invention also relates to a method for damping oscillations or vibrations of vehicle components by applying said anti-drumming composition to vehicle components.

Oscillations or vibrations of machinery or vehicle components generate unwanted noise. For noise reduction, the components can be treated with what are called anti-drumming compositions, also referred to as LASD (liquid applied sound damping) compositions. Vibration-damping materials are described in, for example, Journal of Materials Science 36 (2001) 5733-5737, US 2004/0033354, and U.S. Pat. No. 6,502,821. Geometrically complex, three-dimensional components can be treated by spray application of an anti-drumming composition in the form of an aqueous dispersion. Dispersions of this kind generally comprise a dispersed, viscoelastic polymer and inorganic fillers. Vibration-damping compositions based on water-based polymer dispersions and inorganic fillers along with further auxiliaries are described in EP 1520865, WO 2007/034933, EP 2420412, WO 2012/010632, WO2015/018665 and WO 2015/086465. The quality of a sound deadener composition can be measured by measuring the flexural vibrations by the resonance curve method in accordance with EN ISO 6721-1:2011 and EN ISO 6721-3:1996. One measure of the vibration-damping effect is the loss factor tan delta. When anti-drumming compositions based on viscoelastic polymers are used, the loss factor is temperature-dependent. The desire is for materials which result in a maximum loss factor in the temperature range in which the machinery or vehicles are typically operated, such as between 0 and 40° C.

In the case of anti-drumming compositions based on aqueous systems, particular challenges are posed by the water absorption of the dried compositions on contact with moisture. Drying may be accompanied by unwanted blistering, the formation of larger or smaller pores, or unwanted volume expansion.

WO 2015/086465 describes examples of anti-drumming compositions with water absorption of from 5% to 15% after 24 h and volume expansion after drying of 0.4 mm and more (3 mm of wet coating). The filler mixture has a density of 3.6 kg/dm³. WO 2015/018665 describes examples of anti-drumming compositions with water absorption of from 11% to 19% after 24 h and volume expansion after drying of 1.1 mm and more (3 mm of wet coating). The filler mixtures of the examples have a density of 3.6 kg/dm³. WO 2015/120042 describes coating compositions for sound and vibration damping with water absorption of from 9% to 129%. WO2009/065832 describes coating compositions for automobile construction, containing a filler, which reduces, in particular prevents, bubbling during the transition from the wet state into the dry state, preferably a filler based on aluminum silicate. Volume expansion of the example after drying is 30%, density of the filler in the examples is 3.4 kg/dm³.

It was an object of the present invention to provide further anti-drumming materials having good or improved vibration-damping properties and, in particular, good drying behavior and minimal water absorption on the part of the dried compositions. Preferably, the compositions should show minimum or no run-off on vertical substrates at the time of application.

It has been found that anti-drumming compositions based on aqueous polymer dispersion binders, high density filler mixtures and dispersing aids can be provided, wherein the anti-drumming compositions have good vibration-damping properties and additionally particular low water absorption properties, if the anti-drumming compositions are characterized either by a volume contraction or by a very low volume expansion of less than 3%, based on the wet thickness, upon drying.

The invention accordingly provides an anti-drumming composition comprising
(a) a polymer dispersion comprising at least one dispersed (meth)acrylic polymer obtainable by emulsion polymerization of radically polymerizable (meth)acrylic monomers,
(b) a mixture of inorganic fillers, said mixture having a density of equal to or more than 3.7 kg/dm³;
(c) at least one dispersing aid, said dispersing agent comprising at least one amine group or at least one phosphonate group;
   wherein the anti-drumming composition has either a volume contraction or a volume expansion of less than 6%, based on the wet thickness, after drying a coating at 160° C.

The invention also provides the use of an anti-drumming composition as described herein for vibration damping of bodywork parts of a vehicle or for underbody protection on a motor vehicle.

The invention also provides a method for damping oscillations or vibrations of vehicle components, where
(1) an anti-drumming composition as described herein is provided, and
(2) the anti-drumming composition is applied to a vehicle component and dried.

In the text below, the designation “(meth)acryl . . . ” and similar designations is used as an abbreviating notation for “acryl . . . or methacryl . . . ”. The expression “Cx alkyl(meth)acrylate” encompasses alkyl acrylates and alkyl methacrylates having x C atoms in the alkyl group.

“(Meth)acrylic polymers” are polymers which are predominantly (in total more than 50 wt. %, based on the sum total of all of the monomers of the polymer) composed of (meth)acrylic monomers. (Meth)acrylic monomers include (meth)acrylic acid and (meth)acrylic acid esters.

The term “mixture of inorganic fillers” comprises mixtures of chemically distinct inorganic fillers as well as mixtures of different particle sizes of a single chemical type of an inorganic filler.

A dispersing aid is a substance, typically a surfactant, that is added to a suspension of solid particles in a liquid to improve the separation of the particles and to prevent their settling or clumping.

The polymer dispersions for use in accordance with the invention are dispersions of polymers in an aqueous medium. The aqueous medium may, for example, be exclusively water, or may alternatively be mixtures of water with a water-miscible solvent such as methanol, ethanol, or tetrahydrofuran. It is preferred not to use organic solvents. The solids contents of the dispersions are preferably from 15 to 75 wt. %, more preferably from 40 to 60 wt. %, more particularly greater than 50 wt. %. The solids content may be realized for example through corresponding adjustment to the monomer amounts and/or to the amount of water used in the emulsion polymerization. The average size of the polymer particles dispersed in the aqueous dispersion is preferably less than 400 nm, more particularly less than 300 nm. With particular preference the average particle size is between 140 and 250 nm. By average particle size here is meant the dso of the particle size distribution—that is, 50 wt. % of the entire mass of all the particles have a diameter smaller than the d₅₀. The particle size distribution can be determined in a known way using an analytical ultracentrifuge (W. Machtle, Makromolekulare Chemie 185 (1984), pages 1025-1039). The pH of the polymer dispersion is set preferably to more than 4, more particularly to a pH of between 5 and 9.

The anti-drumming composition comprises preferably 5 to 50 wt. %, more preferably 10 to 35 wt. % of the polymer dispersion (a), the quantity figure being based on the solids content of the polymer dispersion. The polymers prepared by emulsion polymerization are polymers obtainable by radical polymerization of ethylenically unsaturated compounds (monomers). The nature and amount of the monomers are preferably such that the glass transition temperature of the polymer prepared by emulsion polymerization is in the range from −60° C. to less than or equal to 70° C., or in the range from −30° C. to less than or equal to 60° C., more preferably in the range from −15 to 50° C. The glass transition temperature may be determined in the form of what is called the “midpoint temperature” by means of differential scanning calorimetry (ASTM D 3418-08).

The dispersed (meth)acrylic polymer is composed to an extent of preferably at least 60 wt. % or at least 80 wt. %, more preferably at least 85 wt. % or 100 wt. %, of (meth)acrylic monomers. The (meth)acrylic monomers are preferably selected from C1 to C20 alkyl (meth)acrylates, acrylic acid and (meth)acrylic acid. Preferably the dispersed (meth)acrylic polymer is composed to an extent of at least 60 wt. % of alkyl (meth)acrylates having 1 to 10 C atoms in the alkyl group.

Suitable (meth)acrylic monomers are, for example, C1 to C20 alkyl (meth)acrylates, preferably (meth)acrylic acid alkyl esters with a C₁-C₁₀ alkyl radical, such as methyl methacrylate, methyl acrylate, n-butyl acrylate, ethyl acrylate, and 2-ethylhexyl acrylate. In particular, mixtures of the (meth)acrylic acid alkyl esters are suitable as well.

Further monomers, different from (meth)acrylic monomers, are preferably selected from vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers. Vinyl esters of carboxylic acids having 1 to 20 C atoms are, for example, vinyl laurate, vinyl stearate, vinyl propionate, Versatic acid vinyl esters, and vinyl acetate. Vinyl-aromatic compounds include vinyltoluene, alpha- and para-methylstyrene, alpha-butylstyrene, 4-n-butylstyrene, 4-n-decylstyrene, and—preferably—styrene. Examples of nitriles are acrylo-nitrile and methacrylonitrile. The vinyl halides are ethylenically unsaturated compounds substituted by chlorine, fluorine, or bromine, preferably vinyl chloride and vinylidene chloride. Examples of vinyl ethers include vinyl methyl ether or vinyl isobutyl ether. Preferred vinyl ethers are those of alcohols comprising 1 to 4 C atoms. Suitable hydrocarbons having 4 to 8 C atoms and two olefinic double bonds are butadiene, isoprene, and chloroprene, for example.

Preferred monomers are C₁ to C₁₀ alkyl acrylates and C₁ to C₁₀ alkyl methacrylates, more particularly C₁ to C₈ alkyl acrylates and methacrylates, and vinylaromatics, especially styrene, and mixtures thereof. Especially preferred are methyl acrylate, methyl methacrylate, ethyl acrylate, n-butyl acrylate, n-hexyl acrylate, octyl acrylate, and 2-ethylhexyl acrylate, 2-propyl-heptyl acrylate, styrene, and also mixtures of these monomers. More particularly the polymers are composed to an extent of at least 60 wt. %, more preferably at least 80 wt. %, and very preferably at least 90 wt. % of C₁ to C₁₀ alkyl (meth)acrylates.

The polymer preferably comprises one or more monomers with acid groups, examples being ethylenically unsaturated monomers with carboxylic, sulfonic, or phosphonic acid groups (acid monomers). Carboxylic acid groups are preferred. Examples include acrylic acid, methacrylic acid, itaconic acid, maleic acid, or fumaric acid.

The polymer optionally comprises further monomers, for example, also monomers comprising hydroxyl groups, more particularly C₁-C₁₀ hydroxyalkyl (meth)acrylates or (meth)acrylamide. Other further monomers are phenyloxyethyl glycol mono(meth)acrylate, glycidyl (meth)acrylate, aminoalkyl (meth)acrylates such as 2-aminoethyl (meth)acrylate, for example. Alkyl groups have preferably from 1 to 20 C atoms.

Preferably the dispersed (meth)acrylic polymer is composed of
(a) at least one (meth)acrylic alkyl ester monomer which when polymerized as a homopolymer has a glass transition temperature of less than 0° C., preferably of less than −20° C.;
(b) at least one (meth)acrylic alkyl ester monomer which when polymerized as a homopolymer has a glass transition temperature of greater than 0° C., preferably of greater than 50° C.; and
(c) optionally at least one monomer different from the monomers (a) and (b) and having at least one acid group; and
(d) optionally at least one monomer different from the monomers (a), (b) and (c).

A preferred dispersed (meth)acrylic polymer is composed of
(a) 25 to 70 wt. %, preferably 29 to 70 wt. %, of at least one (meth)acrylic alkyl ester monomer which when polymerized as a homopolymer has a glass transition temperature of less than 0° C., preferably of less than −20° C., e.g., n-propyl acrylate, n-butyl acrylate, n-hexyl acrylate, 2-ethylhexyl acrylate
(b) 20 to 70 wt. %, preferably 29 to 70 wt. % of at least one (meth)acrylic alkyl ester monomer which when polymerized as a homopolymer has a glass transition temperature of greater than 0° C., preferably of greater than 50° C. e.g., methyl acrylate, tert-butyl acrylate, methyl methacrylate, ethyl methacrylate, n-butyl methacrylate, isobutyl methacrylate, tert-butyl methacrylate; and
(c) 0 to 5 wt. %, preferably 0.3 to 3 wt. %, of at least one monomer different from the monomers (a) and (b) and having at least one acid group; and
(d) 0 to 20 wt. %, preferably 0.5 to 10 wt. %, of at least one monomer different from the monomers (a), (b) and (c), e.g. acrylonitrile, methacrylonitrile, styrene, vinyl acetate, (meth)acrylamide.

One particularly preferred dispersed (meth)acrylic polymer is composed of
(a) 40 to 70 wt. % of n-butyl acrylate,
(b) 24 to 50 wt. % of methyl methacrylate,
(c) 0.3 to 3 wt. % of at least one acid monomer selected from acrylic acid, methacrylic acid, itaconic acid and mixtures thereof,
(d) 1 to 10 wt. % styrene.

The polymers may be prepared by emulsion polymerization, the product then being an emulsion polymer. In the emulsion polymerization it is usual to use ionic and/or nonionic emulsifiers and/or protective colloids, and/or stabilizers, as interface-active compounds, in order to support the dispersing of the monomers in the aqueous medium. A comprehensive description of suitable protective colloids is found in Houben-Weyl, Methoden der organischen Chemie, volume XIV/1, Makromolekulare Stoffe [Macromolecular compounds], Georg-Thieme-Verlag, Stuttgart, 1961, pp. 411 to 420. Emulsifiers contemplated are anionic, cationic, and nonionic emulsifiers. As accompanying interface-active substances it is preferred to use exclusively emulsifiers, whose molecular weights, in contrast to the protective colloids, are usually below 2000 g/mol. Where mixtures of interface-active substances are used, the individual components must, of course, be compatible with one another, something which in case of doubt can be verified using a few preliminary experiments. Preference is given to using anionic and nonionic emulsifiers as interface-active substances. Suitable emulsifiers are, for example, ethoxylated C₈ to C₃₆ or C₁₂ to C₁₈ fatty alcohols having a degree of ethoxylation of 3 to 50 or of 4 to 30, ethoxylated mono-, di-, and tri- C₄ to C₁₂ or C₄- to C₉ alkylphenols having a degree of ethoxylation of 3 to 50, alkali metal salts of dialkyl esters of sulfosuccinic acid, alkali metal salts and ammonium salts of C₈ to C₁₂ alkyl sulfates, alkali metal salts and ammonium salts of C₁₂ to C₁₈ alkylsulfonic acids, and alkali metal salts and ammonium salts of C₉ to C₁₈ alkylarylsulfonic acids. Cationic emulsifiers are, for example, compounds having at least one amino group or ammonium group and at least one C₈-C₂₂ alkyl group.

Further suitable emulsifiers are compounds of the general formula

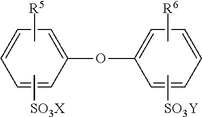

in which R⁵ and R⁶ are hydrogen or C₄ to C₁₄ alkyl and are not simultaneously hydrogen, and X and Y may be alkali metal ions and/or ammonium ions. Preferably, R⁵ and R⁶ are linear or branched alkyl radicals having 6 to 18 C atoms, or hydrogen, and more particularly having 6, 12, and 16 C atoms, with R⁵ and R⁶ not being both simultaneously hydrogen. X and Y are preferably sodium, potassium, or ammonium ions, with sodium being particularly preferred. Particularly advantageous are compounds in which X and Y are sodium, R⁵ is a branched alkyl radical having 12 C atoms, and R⁶ is hydrogen or R⁵. Use is frequently made of technical mixtures which include a fraction of 50 to 90 wt. % of the monoalkylated product, an example being Dowfax® 2A1. Suitable emulsifiers are also found in Houben-Weyl, Methoden der organischen Chemie, Volume 14/1, Makromolekulare Stoffe [Macromolecular compounds], Georg Thieme Verlag, Stuttgart, 1961, pages 192 to 208. Emulsifier trade names are, for example, Dowfax® 2A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol® VSL, Emulphor® NPS 25. Also suitable are copolymerizable emulsifiers which comprise a radically polymerizable, ethylenically unsaturated double bond, examples being reactive anionic emulsifiers such as Adeka® Resoap SR-10.

The emulsion polymerization takes place in general at 30 to 130, preferably 50 to 95° C. or 50 to less than 90° C. The polymerization medium may consist only of water, or of mixtures of water and liquids miscible therewith such as methanol. Preference is given to using just water. The emulsion polymerization may be carried out as a batch operation or in the form of a feed process, including staged or gradient regimes. Preference is given to the feed process, in which a portion of the polymerization batch is introduced as the initial charge and is heated to the polymerization temperature, polymerization is commenced, and the remainder of the polymerization batch is supplied to the polymerization zone, usually via a plurality of spatially separate feeds, of which one or more comprise the monomers in pure form or in emulsified form, the additions taking place continuously, in stages, or under a concentration of gradient, with the polymerization being maintained. For more effective setting of the particle size, for example, it is also possible in the polymerization to include a polymer seed in the initial charge.

The emulsion polymerization can be carried out in the presence of at least one protective colloid. This means that the protective colloids are included in the initial charge or supplied together with monomers to the polymerization vessel. They are preferably included in the initial emulsion polymerization charge, while any emulsifiers employed additionally may be supplied together with the monomers in the course of the polymerization as well.

For the emulsion polymerization it is possible to use the typical and known auxiliaries, such as water-soluble initiators and chain transfer agents, for example. Water-soluble initiators for the emulsion polymerization are, for example, ammonium salts and alkali metal salts of peroxy-disulfuric acid, e.g., sodium peroxodisulfate, hydrogen peroxide, or organic peroxides, e.g., tert-butyl hydroperoxide. Also suitable are what are called reduction-oxidation (redox) initiator systems. The redox initiator systems are composed of at least one usually inorganic reducing agent and one organic or inorganic oxidizing agent. The oxidizing component comprises, for example, the initiators already specified above for the emulsion polymerization. The reducing components comprise, for example, alkali metal salts of sulfurous acid, such as sodium sulfite, sodium hydrogensulfite, alkali metal salts of disulfurous acid such as sodium disulfite, bisulfite addition compounds of aliphatic aldehydes and ketones, such as acetone bisulfite, or reducing agents such as hydroxymethanesulfinic acid and the salts thereof, or ascorbic acid. The redox initiator systems can be used together with soluble metal compounds whose metallic component is able to occur in a plurality of valence states. Examples of typical redox initiator systems include ascorbic acid/iron(II) sulfate/sodium peroxydisulfate, tert-butyl hydro-peroxide/sodium disulfite, tert-butyl hydroperoxide/Na-hydroxymethanesulfinic acid, or tert-butyl hydroperoxide/ascorbic acid. The individual components, the reducing component for example, may also be mixtures, an example being a mixture of the sodium salt of hydroxymethanesulfinic acid and sodium disulfite. The stated compounds are used usually in the form of aqueous solutions, with the lower concentration being determined by the amount of water that is acceptable in the dispersion, and the upper concentration by the solubility of the respective compound in water. In general the concentration is 0.1 to 30 wt. %, preferably 0.5 to 20 wt. %, more preferably 1.0 to 10 wt. %, based on the solution. The amount of the initiators is generally 0.1 to 10 wt. %, preferably 0.5 to 5 wt. %, based on the monomers to be polymerized. It is also possible for two or more different initiators to be used for the emulsion polymerization. For the purpose of removing the residual monomers, it is typical for initiator to be added after the end of the actual emulsion polymerization as well.

In the polymerization it is possible to use chain transfer agents to regulate molecular weight, in amounts, for example, of 0 to 0.8 part by weight, based on 100 parts by weight of the monomers to be polymerized, thereby reducing the molar mass. Suitability is possessed, for example, by compounds having a thiol group such as tert-butyl mercaptan, thioglycolic esters, such as 2-ethylhexyl thioglycolate (EHTG), mercaptoethanol, mercaptopropyl trimethoxysilane, n-dodecyl mercaptan, or tert-dodecyl mercaptan (t-DMK). Preference is given to EHTG or t-DMK. It is additionally possible to use chain transfer agents without a thiol group, such as C6 to C20 hydrocarbons, for example, which form a pentadienyl radical when hydrogen is abstracted, an example being terpinolene. In one embodiment the emulsion polymer is prepared using 0.05 to 0.7 wt. % or less than 0.4 wt. %, based on the monomer amount, of at least one chain transfer agent to regulate molecular weight.

In one embodiment the emulsion polymerization takes place in one stage and/or without protective colloid.

In the emulsion polymerization, aqueous dispersions of the polymer are obtained with solids contents in general of 15 to 75 wt. %, preferably of 40 to 75 wt. %. For a high space/time yield of the reactor, dispersions with as high a solids content as possible are preferred. In order to be able to achieve solids contents >60 wt. %, a bimodal or polymodal particle size ought to be set, since otherwise the viscosity becomes too high and the dispersion is no longer manageable. Producing a new particle generation can be accomplished, for example, by addition of seed (EP 81083), by addition of excess quantities of emulsifier, or by addition of miniemulsions. A further advantage associated with the low viscosity at high solids content is the improved coating behavior at high solids contents. Producing one or more new particle generations can be done at any desired point in time. This point in time is guided by the particle size distribution that is desired for a low viscosity.

In one embodiment the polymer has a core-shell morphology or is preparable by at least two-stage polymerization, with the glass transition temperature of the core-forming polymer (A) differing by at least 10° C., preferably by at least 15° C. or at least 20° C., as for example by 10 to from the glass transition temperature of the shell-forming polymer (B), or with the glass transition temperature of the polymer (B) formed in the first polymerization stage differing from the glass transition temperature of the polymer formed in the second polymerization stage (A) by at least 10° C., preferably by at least 15° C. or at least 20° C., as for example by 10 to 50° C. This embodiment therefore relates to aqueous polymer dispersions in which the polymer particles have at least two polymer phases (A) and (B) which are different from one another and have different glass transition temperatures. An advantage of this is that sound deadener compositions produced accordingly possess vibration-damping activities within a larger temperature range. The glass transition temperature of the core is preferably greater than the glass transition temperature of the shell.

In the case of the core-shell particles, the surface of the core is covered wholly or at least partly with the shell-forming polymer. Core-shell particles preferably have an average particle diameter of 10 nm to 1 micrometer or 20 nm to 500 nm, measurable with a dynamic light-scattering photometer. Both polymer (A) and the polymer (B) different from it are preferably acrylate copolymers, with the nature and amount of the monomers being such as to ensure at least the minimum difference between the glass transition temperatures. Suitable acrylate copolymers for the formation of at least two-phase polymer particles are described in WO 2007/034933, EP 1520865, and DE19954619, for example.

Polymer dispersions with at least two-phase polymer particles are preferably obtainable by radical aqueous emulsion polymerization, comprising the following steps:
a) polymerizing a first monomer batch M1 to give a polymer P1 having a theoretical glass transition temperature Tg(1) (according to Fox) and
b) polymerizing a second monomer batch M2 to give a polymer P2 having a theoretical glass transition temperature Tg(2) (according to Fox), different from Tg(1), in the aqueous dispersion of the polymer P1,
   with the use of at least one chain transfer reagent either during the polymerization of the monomer batch M1 or during the polymerization of the monomer batch M2, preferably.

A theoretic glass transition temperature is understood, here and below, to be the glass transition temperature Tg(1) or Tg(2), calculated according to Fox on the basis of the monomer composition of the monomer batch M1 and of the monomer batch M2, respectively. According to Fox (T. G. Fox, Bull. Am. Phys. Soc. (Ser. II) 1, 123 and Ullmann's Enzyklopädie der technischen Chemie, Weinheim (1980), pp. 17, 18), the glass transition temperature of copolymers of high molar masses is given in good approximation by

1/Tg=x1/Tg(1)+x2/Tg(2)+ . . . +xn/Tg(n)

where x1, x2, . . . xn are the mass fractions 1, 2, . . . , n, and Tg(1), Tg(2), . . . , Tg(n) are the glass transition temperatures of the polymers constructed in each case only from one of the monomers 1, 2, . . . , n, in degrees Kelvin. The latter are known from, for example, Ullmann's Encyclopedia of Industrial Chemistry, VCH, Weinheim, vol. A 21 (1992) p. 169, or from J. Brandrup, E. H. Immergut, Polymer Handbook 3rd edn., J. Wiley, New York 1989.

With preference in accordance with the invention the monomer batch M2 is selected such that the theoretical glass transition temperature (according to Fox) of the resultant polymer phase P2 lies above the theoretical glass transition temperature of the polymer P1 prepared first. In that case the monomer batch M2 preferably has a composition which leads to a theoretical glass transition temperature Tg(2) for the polymer phase P2 that is above 30° C., preferably above and more particularly in the range from 50 to 120° C. If Tg(2) is greater than Tg(1), the monomer batch M1 preferably has a monomer composition which leads to a theoretical glass transition temperature Tg(1) for the resulting polymer phase P1 that is in the range from −40 to +40° C., preferably in the range from −30 to +30° C., and very preferably in the range from −10 to +25° C. If Tg(1) is greater than Tg(2), the preferred glass transition temperatures of the polymer phase P1 are subject to the same statements as made above for P2 in the case where Tg(2) is greater than Tg(1). In that case, accordingly, the glass transition temperatures of the polymer phase P2 are subject to the statements made above for Tg(1).

In the polymer dispersions of the invention, the weight ratio of the polymer phases to one another is in the range from 20:1 to 1:20, preferably 9:1 to 1:9. The invention gives preference to those polymer dispersions in which the fraction of polymer phase having the low glass transition temperature is predominant. If, as preferred in accordance with the invention, P1 has the lower glass transition temperature, the ratio P1:P2 is situated in particular in the range from 1:1 to 5:1, and with particular preference in the range from 2:1 to 4:1. The weight ratios of the polymer phases P1 and P2 here correspond approximately to the proportions of the monomer batches M1 and M2. In the case of Tg(1) greater than Tg(2), the proportions P1:P2 are situated in particular in the range from 1:1 to 1:5 and more preferably in the range from 1:2 to 1:4.

The anti-drumming composition comprises a mixture of inorganic fillers, said mixture having a density of equal to or more than 3.7 kg/dm³. The density is the average density based on the total amount of inorganic fillers and can be calculated from the amounts and individual densities of the individual inorganic fillers. Excluded from the calculation of the density of the inorganic fillers is glass material characterized by having hollow areas incorporated within a closed glass shell (for example glass beads or hollow glass) resulting in bulk densities lower than the density of the glass material itself (glass density is 2.5 g/m³). Although such low-density glass material may be included in the anti-drumming compositions, their density is not included in the density calculation of the inorganic fillers according to the invention. The anti-drumming composition comprises the mixture of inorganic fillers in an amount of preferably 40 to 85 wt. %, or 50 to 80 wt. %, more preferably 60 to 70 wt. %.

Inorganic fillers with densities higher than 3.7 kg/dm³ (for example barium sulfate with density 4.5 kg/dm³) can be used in combination with inorganic fillers with densities lower than 3.7 kg/dm³ (for example calcium carbonate with density 2.7 kg/dm³) in such amounts so that the average density of the mixture is equal to or more than 3.7 kg/dm³.

Suitable inorganic fillers are, for example, barium sulfate, wollastonite, calcium carbonate, kaolin, mica, silica, chalk, microdolomite, finely ground quartz, mica, talc, clay, argillaceous earth, iron oxide, titanium dioxide, zinc oxide, magnetite, glass powder, glass flakes, magnesium carbonate, aluminum hydroxide, bentonite, fly ash, kieselguhr, perlite, carbon black, graphite, clay minerals, microdolomite and finely ground quartz.

Preferred inorganic fillers with high density are barium sulfate, zinc oxide and titanium oxide, most preferred barium sulfate, which can be combined with inorganic fillers of lower density, for example wollastonite, calcium carbonate, mica, kaolin, silica, chalk or talc.

It has been found that high density fillers may increase the risk of run-off of the anti-drumming compositions when applied to vertical substrate surfaces and it has been found that run-off of such “heavy” compositions can be minimized or prevented by including solid materials with anisotropic particle geometry. Therefore, the anti-drumming composition preferably comprises at least one dispersed, solid material with anisotropic particle geometry. Preferably, the anti-drumming composition comprises at least one needle-shaped filler or at least one platelet-shaped inorganic filler which may also be effective as thickener or (most preferred) a combination of both. A preferred needle-shaped inorganic filler is wollastonite. Anisotropic particle geometry means non-spherical particles with an aspect ratio of more than 1.5, preferably at least 4.

A preferred filler mixture comprises
(b1) at least one inorganic filler material with a density of at least 4 g/cm³, preferably barium sulfate or zinc oxide or titanium oxide and
(b2) at least one silicate with needle-shaped particle shape, preferably wollastonite;
   in a weight ratio of (b1):(b2) preferably from 0.7 to 150, most preferably 1 to 15, provided, that the density of the mixture is not less than 3.7 kg/dm³.

The anti-drumming composition comprises at least one dispersing aid. The dispersing agent is a compound comprising at least one amine group, or a compound comprising at least one phosphonate group or a mixture thereof. The anti-drumming composition comprises the dispersing aid in amounts of preferably from 0.05 to 5 wt. %, or from 0.2 to 2 wt. %

A suitable dispersing aid is a polymer comprising amine groups, preferably a polyacrylate comprising amine groups, more preferably a polyacrylate with amine number from 10 and 50 mg KOH/g, or from 12 bis 30 mg KOH/g. An example is available as Dispex® Ultra PA 4560 (modified polyacrylate polymer solution in water with an amine number of 25 mg KOH/g).

Another suitable dispersing aid is compound with at least one phosphonate group, for example non-polymeric phosphoric acid esters, sodium hexametaphosphate, non-polymeric phospho-nates, sodium tripolyphosphate. Preferred dispersing aids are non-polymeric chelating agents comprising one or more, preferably at least two phosphonate groups, in particular anionic phosphonate salt chelating agents. An example is Dispex® Ultra FA 4404 (aqueous solution of phosphonate salt; P,P′-(1-hydroxyethylidene)bis-phosphonic acid; preferably partially neutralized, e.g. with 2-aminoethanol).

The invention also provides an anti-drumming composition comprising
(a) 5 to 50 wt. %, preferably 5 to 20 wt. % of the polymer dispersion, the quantity figure being based on the solids content of the polymer dispersion,
(b) 40 to 85 wt., % preferably 60 to 70 wt. % of the mixture of inorganic fillers,
(c) 0.2 to 2 wt. % of the dispersing aids,
(d) 0 to 40 wt. %, preferably 1 to 20 wt. % or 1 to 10 wt. % of organic fillers,
(e) 10 to 40 wt. %, preferably 20 to 30 wt. % of water, and
(f) 0 to 15 wt. %, preferably 0.1 to 7 wt. % or 0.5 to 5 wt. % of auxiliaries.

Suitable organic fillers are, for example, powder coating materials, examples being epoxy powder coating materials, polymer powders of, for example, ground solid ethylene/vinyl acetate copolymer (EVA) resins, dried acrylate dispersions, and polysaccharides, for example starch or agar.

The anti-drumming composition according to the invention can comprise auxiliaries (in addition to dispersing aids c), which are used preferably at not less than 0.1 wt. %, as for example from 0.1 to 10 wt. % or from 0.2 to 5 wt. % or from 0.2 to 3 wt. %. Examples are organic thickeners, resins, plasticizers, cosolvents, stabilizers, wetting agents, preservatives, foam inhibitors, hollow particles, plastics bodies, antifreeze agents, hydrophobizing agents, antioxidants, UV absorbers, emulsifiers, siloxanes, organically modified siloxanes, and antistatic agents. Auxiliaries can include hollow particles such as organic beads or plastic beads, glass beads or hollow glass. Such materials are characterized by having areas incorporated within a closed shell resulting in bulk densities within a medium lower than the density of the material itself. Hollow glass particles are considered as auxiliaries and are not considered as inorganic fillers. Of the auxiliaries it is possible to use one, two or more in combination. Suitable cosolvents are, for example, propylene glycol, ethylene glycol, diethylene glycol, ethylene glycol alkyl ethers (e.g., Cellosolve® products), diethylene glycol alkyl ethers (e.g., Carbitol® products), carbitol acetate, butylcarbitol acetate, or mixtures thereof.

Organic thickeners are, for example, polyvinyl alcohols, cellulose derivatives, polyacrylic acids, or acrylic acid/acrylate ester copolymers in amounts of, for example, 0.01 to 4 or of 0.05 to 1.5 or of 0.1 to 1 part by weight, based on 100 parts by weight of solid. Preferred inorganic thickeners are inorganic fillers with anisotropic particle geometry which are effective as thickeners, preferably with an aspect ratio of at least 4 or more than 4. The anti-drumming composition according to the invention preferably comprises at least one platelet-shaped inorganic filler which also is effective as thickener. An example is attapulgit (e.g. Attagel® 40).

Antifreeze agents are, for example, ethylene glycol or propylene glycol. Foam inhibitors are, for example, silicones. Stabilizers are, for example, polyvalent metal compounds such as zinc oxide, zinc chloride, or zinc sulfate. In one embodiment the sound deadener composition comprises no fluorinated compound.

Conventional anti-drumming compositions which are based on aqueous dispersion binders typically have a substantial volume expansion when dried after their application. It has been found that the problem of unwanted water absorption properties can be minimized by providing anti-drumming compositions which have very low volume expansions or preferably a volume contraction (i.e. negative volume expansion) based on the wet thickness, after drying a coating at 160° C., when combined with high density fillers and specifically selected dispersing aids. The anti-drumming compositions of the invention have a volume contraction or a volume expansion of less than 6%, based on the wet thickness, after drying a coating at 160° C. Preferably the volume expansion is less than 3%, more preferred less than 0% (i.e. a volume contraction).

Volume expansion is measured by applying an anti-drumming compositions with a measured wet thickness to a cathodic dip painted metal sheet metal and drying for 30 minutes at 160° C. The volume expansion E is the difference of dry thickness D and wet thickness W in relation to the wet thickness in percent: E=(D−W)/W*100%. Details of the method are described in the examples.

The maximum of the loss factor tan delta for sound deadener compositions of the invention is preferably in the range from −30 to +60° C. Where core-shell particles or other particles having a multiphase particle structure are used, the different polymer phases having different glass transition temperatures, there are in general at least two maxima for the loss factor at not less than two different temperatures. In this case preferably all of the maxima of the loss factor are situated in the range from −30 to +60° C.

The anti-drumming compositions have a water absorption after 24 hours of preferably less than 5%. The water absorption after 2 days is preferably less than 8%. The Water absorption is measured by applying an anti-drumming compositions to a cathodic dip painted metal sheet and drying for 30 minutes at 160° C. The dried substrate is stored in demineralized water for 24 hours. Water absorption is the relative weight increase during water storage in percent. Details of the method are described in the examples.

The invention also provides a use of the anti-drumming composition of the invention for vibration damping of bodywork parts of a vehicle; or for underbody protection on a motor vehicle; or for cavity sealing in motor vehicles.

The invention also provides a method for damping oscillations or vibrations of vehicle components, where
(1) an anti-drumming composition according to the invention is provided, and
(2) the anti-drumming composition is applied to a vehicle component and dried.

Application may take place in a usual way, as for example by spreading, rolling, or spraying. The applied thickness is preferably from 1 to 8 mm before drying. The applied amount is preferably from 1 to 7 kg/m² or from 2 to 6 kg/m² after drying. Drying may take place at ambient temperature or preferably by application of heat. The drying temperatures are preferably from to 210° C. or from 90 to 180° C. or from 120 to 170° C.

The anti-drumming composition may be employed, for example, in vehicles of all kinds, more particularly road motor vehicles, automobiles, rail vehicles, and also in boats, aircraft, electrical machinery, construction machinery, and buildings. The anti-drumming composition can also be used for underbody protection or for cavity sealing in the vehicles mentioned above.

The sound deadener compositions of the invention have good performance properties in terms of high ease of application, good vibration-damping properties, good drying behavior, and low water absorption and good porosity of the dried compositions.

### EXAMPLES

| Materials used: | |
|---|---|
| D1 | aqueous dispersion of acrylic polymer made of 340 weight parts n-butyl |
| | acrylate, 220 weight parts methyl methacrylate, 30 weight parts styrene |
| | and 6 weight parts acrylic acid; pH adjusted to 7 to 9; |
| | weight average molecular weight: 74600 |
| Acronal ® 3902 | binder for vibration damping compounds; aqueous dispersion of an |
| | acrylic ester copolymer |
| Attagel ® 40 | inorganic thickener; inert powdered gelling grade of attapulgite (density |
| | 2.2 g/cm³) |
| Vansil ® W 10 | wollastonite |
| Omyacarb ® 15-GU | CaCO₃ of Omya GmbH |
| Poraver ® | expanded glass, 40-125 μm (Blähglas), |
| Dispex ® Ultra PA 4560 | modified polyacrylate polymer solution in water; dispersing aid |
| | amine number 25 mg KOH/g |
| Dispex ® AA 4040 | anionic dispersing aid based on polyacrylic acid; solution of ammonium |
| | polyacrylate in water |
| Dispex ® CX 4231 | anionic dispersing aid based on polyacrylic acid; solution of ammonium |
| | polyacrylate in water |
| Dispex ® CX 4340 | anionic dispersing aid based on polyacrylic acid; solution of sodium |
| | polyacrylate in water |
| Dispex ® Ultra FA 4404 | anionic dispersing aid; chelating agent; aqueous solution of P,P′-(1- |
| | hydroxyethylidene)bis-phosphonic acid, partially neutralized with 2- |
| | aminoethanol |
| Loxanol ® MI 6840 | aqueous dispersion of paraffin wax; hydrophobizing agent |
| Expancel ® 031 WUF | wet unexpanded thermoplastic microspheres; organic filler |
| Hexamoll ® DINCH | plasticizer |
| Lumiten ® I-SC | anionic surfactant |
| Natrosol ® 250 HBR | Thickener; water soluble hydroxyethyl cellulose |

### Molecular Weight Measurement

The weight-average molecular weight is measured by means of gel permeation chromatography (GPC) by the method of size exclusion chromatography (SEC). The elution curve is converted into the molecular weight distribution curve with the aid of a polystyrene calibration curve. Only the soluble fractions are subjected to measurement; insoluble gel fractions are removed by filtration.

### Example A1

An anti-drumming composition is prepared at room temperature by mixing 136.9 g BaSO4 (Schwerspat EWO of Sachtleben Chemie), 82.2 g wollastonite (Vansil® W 10), 97.6 g polymer dispersion D1, 1.37 g Attagel® 40, 2.4 g Dispex® Ultra PA 4560, 3.3 g propylene glycol, Loxanol® MI 6840 und 1.83 g Expancel® 031 WUF, by means of a dissolver-stirrer, and the mixture is subsequently homogenized in a Speedmixer.

Density of the mixture of inorganic fillers: 3.8 kg/dm³

### Example A2

An anti-drumming composition is prepared at room temperature by mixing 136.9 g BaSO4 (Barytmehl N of Sachtleben Chemie), 82.2 g wollastonite (Vansil® W 10), 97.6 g polymer dispersion D1, 1.37 g Attagel® 40, 2.4 g Dispex® Ultra PA 4560, 3.3 g propylene glycol, Loxanol® MI 6840 und 1.83 g Expancel® 031 WUF, by means of a dissolver-stirrer, and the mixture is subsequently homogenized in a Speedmixer.

Density of the mixture of inorganic fillers: 3.8 kg/dm³

### Example A3 (Comparative)

An anti-drumming composition is prepared at room temperature by mixing 57.6 g Omyacarb® 15-GU, 10.5 g wollastonite (Vansil® W 10), 10.5 g Poraver® 40-125 μm, 47.3 g polymer dispersion D1, 0.49 g water, 1.05 g Hexamoll® DINCH (plasticizer), 0.79 g Dispex® Ultra PA 4560, 0.27 g Lumiten® I-SC and 1.57 g agar, by means of a dissolver-stirrer, and the mixture is subsequently homogenized in a Speedmixer.

Density of the mixture of inorganic fillers: 2.5 kg/dm³

### Example A4: (Comparative)

An anti-drumming composition is prepared at room temperature by mixing 84.6 g Omyacarb® 15-GU, 37.9 g Acronal® 3902, 0.21 g Natrosol® 250 HBR 2.3 g water, 1.04 g ethanol, 0.82 g Dispex® AA 4040, and 3.17 g starch, by means of a dissolver-stirrer, and the mixture is subsequently homogenized in a Speedmixer.

Density of the mixture of inorganic fillers: 2.7 kg/dm³

### Example A5 (Comparative)

An anti-drumming composition is prepared at room temperature by mixing 74.0 g Omyacarb® 15-GU, 10.6 g wollastonite (Vansil® W 10), 37.9 g Acronal® 3902, 0.21 g Natrosol® 250 HBR, 2.3 g water, 1.04 g ethanol, 0.82 g Dispex® AA 4040, and 3.17 g starch, by means of a dissolver-stirrer, and the mixture is subsequently homogenized in a Speedmixer.

Density of the mixture of inorganic fillers: 2.7 kg/dm³

### Example A6

An anti-drumming composition is prepared at room temperature by mixing 70.8 g BaSO4 (Barytmehl N of Deutsche Barytindustrie), 16.3 g wollastonite (Wollastonite LAR 325 of Kärtner Montanindustrie), 38.8 g polymer dispersion D1, 0.54 g Attagel® 40, 1.36 g Dispex® Ultra PA 4560, 1.3 g propylene glycol, 0.16 g water, 0.73 g Expancel® 031 WUF, by means of a dissolver-stirrer, and the mixture is subsequently homogenized in a Speedmixer.

Density of the mixture of inorganic fillers: 4.1 kg/dm³

### Example A7 (Comparative)

An anti-drumming composition is prepared at room temperature by mixing g BaSO4 (Barytmehl N of Deutsche Barytindustrie), 16.3 g wollastonite (Wollastonite LAR 325 of Kärtner Montanindustrie), 38.7 g polymer dispersion D1, 0.60 g Attagel® 40, 1.81 g Dispex® CX 4231, 1.3 g propylene glycol, 0.72 g Expancel® 031 WUF, by means of a dissolver-stirrer, and the mixture is subsequently homogenized in a Speedmixer.

Density of the mixture of inorganic fillers: 4.1 kg/dm³

### Example A8 (Comparative)

An anti-drumming composition is prepared at room temperature by mixing g BaSO4 (Barytmehl N of Deutsche Barytindustrie), 16.3 g wollastonite (Wollastonite LAR 325 of Kärtner Montanindustrie), 38.8 g polymer dispersion D1, 0.65 g Attagel® 40, 1.33 g Dispex® CX 4340, 1.3 g propylene glycol, 0.21 g water, 0.73 g Expancel® 031 WUF, by means of a dissolver-stirrer, and the mixture is subsequently homogenized in a Speedmixer.

Density of the mixture of inorganic fillers: 4.1 kg/dm³

### Example A9

An anti-drumming composition is prepared at room temperature by mixing 71.1 g BaSO4 (Barytmehl N of Deutsche Barytindustrie), 16.4 g wollastonite (Wollastonite LAR 325 of Kärtner Montanindustrie), 38.8 g polymer dispersion D1, 0.54 g Attagel® 40, 1.09 g Dispex® Ultra FA 4404, 1.3 g propylene glycol, 0.44 g water, 0.72 g Expancel® 031 WUF, by means of a dissolver-stirrer, and the mixture is subsequently homogenized in a Speedmixer.

Density of the mixture of inorganic fillers: 4.1 kg/dm³

### Example A10 (Comparative)

An anti-drumming composition is prepared at room temperature by mixing 70.5 g BaSO4 (Barytmehl N of Deutsche Barytindustrie), 16.3 g wollastonite (Wollastonite LAR 325 of Kärtner Montanindustrie), 38.7 g polymer dispersion D1, 0.91 g Attagel® 40, 1.21 g Dispex® AA 4040, 1.3 g propylene glycol, 0.37 g water, 0.72 g Expancel® 031 WUF, by means of a dissolver-stirrer, and the mixture is subsequently homogenized in a Speedmixer.

Density of the mixture of inorganic fillers: 4.1 kg/dm³

### Description of Mixing Assemblies

Speedmixer: a DAC 400FVZ SpeedMixer from Hausschild is employed.

Dissolver-stirrer: The apparatus consists of a stirrer mechanism, a shaft driven by said mechanism, and a dissolver disk as stirring tool.

### Determination of Density

The densities as provided by the material suppliers are used to calculate the densities of the inorganic filler mixtures.

### Measurement of the Loss Factor

To assess the vibration-damping behavior, the loss factor tan delta at 20° C. is measured as described in WO 2007/034933 (in analogy to ISO 6721-1 and ISO 6721-3). For this purpose, a steel sheet test specimen with a size of 30×300×1.6 mm is coated with the sound deadener composition under test, and dried at 160° C. for 30 minutes.

The coating quantity is approximately 3.0 kg per m².

### Measurement of Volume Expansion

Volume expansion is measured by applying an anti-drumming compositions with a measured wet thickness and an edge length of 60 mm×100 mm to a cathodic dip painted metal sheet and drying for 30 minutes at 160° C. The volume expansion E is the difference of dry thickness D and wet thickness W in relation to the wet thickness in percent: E=(D−W)/W*100%.

### Measurement of Water Absorption

Water absorption is measured by applying the anti-drumming compositions to a cathodic dip painted metal sheet as describe above and drying for 30 minutes at 160° C. The dried substrate is stored in demineralized water for a given duration (e.g. 24 hours; or 2 days). Water absorption is the relative weight increase during water storage in percent.

The results are summarized in table 1.

TABLE 1
Results of the performance tests:

| | Inorganic | | Wet | Volume | | | Loss |
|---|---|---|---|---|---|---|---|
| | filler density | | thickness | expansion | WA-1 d | WA-2 d | factor tan |
| Example | [kg/dm³] | Dispersing aid | [mm] | [mm]; [%] | [%] ²⁾ | [%] ³⁾ | delta |
| A1 | 3.8 | Dispex ® Ultra | 2 | −0.2; −10% | 1.6 | 2.6 | 0.23 |
| | | PA 4560 | | | | | |
| A2 | 3.8 | Dispex ® Ultra | 1.9 | −0.3; −16% | 1.6 | 3.0 | 0.22 |
| | | PA 4560 | | | | | |
| A3 ¹⁾ | 2.5 | Dispex ® Ultra | 3 | +0.8; +27% | 33 | 44.4 | 0.24 |
| | | PA 4560 | | | | | |
| A4 ¹⁾ | 2.7 | Dispex ® AA | 3 | +1.5; +50% | 16 | 23.2 | 0.23 |
| | | 4040 | | | | | |
| A5 ¹⁾ | 2.7 | Dispex ® AA | 3 | +1.6; +53% | 21 | 33.5 | 0.22 |
| | | 4040 | | | | | |
| A6 | 4.1 | Dispex ® Ultra | 1.9 | −0.6; −32% | 3.8 | 6.4 | 0.15 |
| | | PA 4560 | | | | | |
| A7 ¹⁾ | 4.1 | Dispex ® CX | 1.7 | +0.6; +35% | 28 | 34.7 | 0.17 |
| | | 4231 | | | | | |
| A8 ¹⁾ | 4.1 | Dispex ® CX | 1.9 | +8.4; +442% | 65 | 64.0 | 0.15 |
| | | 4340 | | | | | |
| A9 | 4.1 | Dispex ® Ultra | 1.8 | −0.4; −22% | 4.1 | 4.7 | 0.17 |
| | | FA 4404 | | | | | |
| A10 ¹⁾ | 4.1 | Dispex ® AA | 1.8 | +11; +611% | 55 | 50.2 | 0.17 |
| | | 4040 | | | | | |

¹⁾ comparative experiments;
²⁾ water absorption after one day (24 h)
³⁾ water absorption after two days

The results show that the problem of unwanted water absorption properties can be minimized by providing anti-drumming compositions which have very low volume expansions or preferably a volume contraction (i.e. negative volume expansion) based on the wet thickness, after drying a coating at 160° C., when combined with high density fillers and specifically selected dispersing aids.

1-15. (canceled)

16. An anti-drumming composition comprising
(a) a polymer dispersion comprising at least one dispersed (meth)acrylic polymer obtainable by emulsion polymerization of radically polymerizable (meth)acrylic monomers,
(b) a mixture of inorganic fillers, said mixture having a density of equal to or more than 3.7 kg/dm³;
(c) at least one dispersing aid, said dispersing agent comprising at least one amine group or at least one phosphonate group;
wherein the anti-drumming composition has either a volume contraction or a volume expansion of less than 6%, based on the wet thickness, after drying a coating at 160° C.

17. The anti-drumming composition according to claim 16, wherein the dispersing aid is selected from polyacrylates with amine number between 10 and 50 mg KOH/g; and
anionic phosphonate salt chelating agents.

18. The anti-drumming composition according to claim 16, wherein the composition comprises dispersed particles with anisotropic geometry, preferably with an aspect ratio of more than 1.5.

19. The anti-drumming composition according to claim 18, wherein the dispersed particles with anisotropic geometry are at least one needle-shaped filler and/or at least one platelet-shaped inorganic filler which is effective as thickener.

20. The anti-drumming composition according to claim 16, wherein the dispersed (meth)acrylic polymer is composed to an extent of at least 60 wt. % of alkyl (meth)acrylates having 1 to 10 C atoms in the alkyl group.

21. The anti-drumming composition according to claim 16, wherein the dispersed (meth)acrylic polymer is composed of
(a) 25 to 70 wt. % of at least one (meth)acrylic alkyl ester monomer which when polymerized as a homopolymer has a glass transition temperature of less than 0° C.;
(b) 20 to 70 wt. % of at least one (meth)acrylic alkyl ester monomer which when polymerized as a homopolymer has a glass transition temperature of greater than 0° C.; and
(c) 0 to 5 wt. % of at least one monomer different from the monomers (a) and (b) and having at least one acid group; and
(d) 0 to 20 wt. % of at least one monomer different from the monomers (a), (b) and (c).

22. The anti-drumming composition according to claim 16, wherein the dispersed (meth)acrylic polymer is composed of
(a) 40 to 70 wt. % of n-butyl acrylate,
(b) 24 to 50 wt. % of methyl methacrylate,
(c) 0.3 to 3 wt. % of at least one acid monomer selected from acrylic acid, methacrylic acid, itaconic acid and mixtures thereof,
(d) 1 to 10 wt. % styrene.

23. The composition according to claim 16, wherein the glass transition temperature of the polymer prepared by emulsion polymerization is in the range from −60° C. to less than or equal to +70° C., measured as the midpoint temperature by means of differential scanning calorimetry according to ASTM D 3418-08.

24. The anti-drumming composition according to claim 16, comprising
(a) 5 to 50 wt. % of the polymer dispersion, the quantity figure being based on the solids content of the polymer dispersion,
(b) 40 to 85 wt. % of the mixture of inorganic fillers,
(c) 0.2 to 2 wt. % of the dispersing aids
(d) 0 to 40 wt. % of organic fillers,
(e) 10 to 40 wt. % of water, and
(f) 0 to 10 wt. % of auxiliaries.

25. The anti-drumming composition according to claim 16, wherein the filler mixture comprises
(b 1) at least inorganic filler material with a density of at least 4 g/cm³, and
(b2) at least one silicate with needle-shaped particle shape, preferably wollastonite; in a weight ratio of (b1):(b2) from 0.7 to 150, provided that the density of the mixture is not less than 3.7 kg/dm³.

26. The anti-drumming composition according to claim 16, wherein the composition comprises the auxiliaries in an amount of not less than 0.1 wt. % and the auxiliaries are selected from organic thickeners, resins, plasticizers, cosolvents, stabilizers, wetting agents, preservatives, foam inhibitors, hollow particles, plastics bodies, antifreeze agents, hydrophobizing agents, antioxidants, UV absorbers, emulsifiers, siloxanes, organically modified siloxanes, and antistatic agents.

27. The anti-drumming composition according to claim 16, wherein the composition comprises at least one platelet-shaped inorganic filler which is effective as thickener.

28. The anti-drumming composition according to claim 16, wherein the water-absorption after 24 hours is less than 5%.

29. A method for vibration damping of bodywork parts of a vehicle; or for underbody protection of motor vehicles; or for cavity sealing in motor vehicles comprising the anti-drumming composition according to claim 16.

30. A method for damping oscillations or vibrations of vehicle components, where
(1) an anti-drumming composition according to claim 16 is provided, and
(2) the anti-drumming composition is applied to a vehicle component and dried.
